(19) United States
(12) Patent Application Publication
(10) Pub. No.: US 2025/0192362 A1
(43) Pub. Date: Jun. 12, 2025

(54) SEPARATOR FOR RECHARGEABLE LITHIUM BATTERY AND RECHARGEABLE LITHIUM BATTERY INCLUDING SAME

(71) Applicant: SAMSUNG SDI CO., LTD., Gyeonggi-do (KR)

(72) Inventors: Jinyoung KIM, Gyeonggi-do (KR); Hyeonseon CHOI, Gyeonggi-do (KR); Dongwan SEO, Gyeonggi-do (KR)

(73) Assignee: SAMSUNG SDI CO., LTD., Gyeonggi-do (KR)

(21) Appl. No.: 18/845,644

(22) PCT Filed: Feb. 17, 2023
(86) PCT No.: PCT/KR2023/002346

§ 371 Date: Sep. 10, 2024

(30) Foreign Application Priority Data
Apr. 15, 2022 (KR) 10-2022-0047170

(51) Int. Cl. H01M 50/417; H01M 10/0525; H01M 50/434; H01M 50/446; H01M 50/449; H01M 50/46

(52) U.S. Cl. CPC H01M 50/417; H01M 50/434; H01M 50/446; H01M 50/449; H01M 50/461; H01M 10/0525

(57) ABSTRACT

Provided are a separator for a rechargeable lithium battery and a rechargeable lithium battery including same and the separator for a rechargeable lithium battery comprising: a porous substrate, a coating layer positioned on at least one surface of the porous substrate and comprising polyethylene particles and a first ceramic at a weight ratio of 6:4 to 8:2, and an adhesive layer positioned on one surface of the coating layer and comprising a second ceramic and a binder at a weight ratio of 7:3 to 5:5, wherein the binder comprises polyvinylidene fluoride and a polyvinylidene-hexapropylene copolymer at a weight ratio of 6:4 to 4:6, and the first ceramic and the second ceramic have different average sizes.

### TECHNICAL FIELD

A separator for a rechargeable lithium battery and a rechargeable lithium battery including the same are disclosed.

### BACKGROUND ART

Rechargeable lithium batteries have a high discharge voltage and high energy density, and are attracting attention as a power source for various electronic devices.

A rechargeable lithium battery is arranged so that the positive and negative electrodes may face each other, has a structure filled with an electrolyte, and a separator is located between the positive and negative electrodes to prevent short circuit. The separator may be a porous material that may transfer ions or electrolytes.

If a battery is exposed to a high temperature environment due to abnormal behavior, a separator may mechanically shrink or be damaged due to melting characteristics at a low temperature. Herein, the positive and negative electrodes contact each other and may cause an explosion of the battery. In order to solve the problems, technology is needed to suppress shrinkage of the separator and ensure the safety of the battery.

### DISCLOSURE

### Technical Problem

An embodiment is to provide a separator for a rechargeable lithium battery with excellent safety.

Another embodiment provides a rechargeable lithium battery including the separator.

### Technical Solution

According to an embodiment, a separator for a rechargeable lithium battery includes a porous substrate; a coating layer positioned on at least one surface of the porous substrate and including polyethylene particles and a first ceramic in a weight ratio of 6:4 to 8:2; and an adhesive layer positioned on one surface of the coating layer and including a second ceramic and a binder in a weight ratio of 7:3 to 5:5, the binder includes polyvinylidene fluoride and a polyvinylidene-hexapropylene copolymer in a weight ratio of 6:4 to 4:6, and the first ceramic and the second ceramic have different average sizes.

A mixing ratio of the second ceramic and the binder may be a weight ratio of 6:4 to 5:5.

An average size of the first ceramic may be larger than an average size of the second ceramic.

An average size of the first ceramic may be 550 nm to 750 nm.

A thickness of a single layer of the coating layer may be 0.5 μm to 5 μm.

A thickness of a single layer of the adhesive layer may be 0.1 μm to 4.0 μm.

A size ratio of the first ceramic and the second ceramic may be 5:1 to 1.5:1.

The first ceramic or the second ceramic are the same or different from each other, Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

In an embodiment, the first ceramic may be boehmite, and the second ceramic may be Al₂O₃.

The coating layer may further include a vinyl group-containing binder. The vinyl group-containing binder may include a (meth)acrylic copolymer including a first structural unit derived from (meth)acrylamide, and a second structural unit including at least one of a structural unit derived from (meth)acrylic acid, (meth)acrylate, (meth)acrylonitrile, or a combination thereof, and a structural unit derived from (meth)acrylamidosulfonic acid, a (meth)acrylamidosulfonate salt, or a combination thereof.

According to another embodiment, a rechargeable lithium battery includes a negative electrode including a negative electrode active material; a positive electrode including a positive electrode active material; a separator positioned between the negative electrode and the positive electrode; and a non-aqueous electrolyte.

Details of other embodiments are included in the detailed description below.

### Advantageous Effects

A separator for a rechargeable lithium battery according to an embodiment has excellent adhesive force to an electrode, and can exhibit excellent cycle-life characteristics and excellent air permeability characteristics.

### DESCRIPTION OF THE DRAWINGS

FIG. 1 is a view briefly showing a rechargeable lithium battery according to an embodiment.

### MODE FOR INVENTION

Hereinafter, embodiments of the present invention are described in detail. However, these embodiments are exemplary, the present invention is not limited thereto and the present invention is defined by the scope of claims. The terminology used herein is used to describe embodiments only, and is not intended to limit the present disclosure. The singular expression includes the plural expression unless the context clearly dictates otherwise.

“Combination thereof” means a mixture, laminate, composite, copolymer, alloy, blend, reaction product, and the like of the constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Thickness” may be measured through a photograph taken with an optical microscope such as a scanning electron microscope.

The average size may refer to an average particle diameter (D50), and in the present specification, when a definition is not otherwise provided, an average particle diameter (D50) indicates a particle where a cumulative volume is about 50 volume % in a particle distribution.

The average particle size (D50) may be measured by a method well known to those skilled in the art, for example, by a particle size analyzer, a transmission electron microscope image, or a scanning electron microscope image. Alternatively, a dynamic light-scattering measurement device is used to perform a data analysis, and the number of particles is counted for each particle size range. From this, the average particle diameter (D50) value may be easily obtained through a calculation.

An embodiment provides a separator for a rechargeable lithium battery including a porous substrate, a coating layer positioned on at least one surface of the porous substrate, and an adhesive layer positioned on one surface of the coating layer.

The coating layer may include polyethylene particles and the first ceramic in a weight ratio of 6:4 to 8:2. In the coating layer, if the weight ratio of the polyethylene particles and the first ceramic is outside the above range, for example, if too much polyethylene particles are used, it is difficult to form a coating layer, the air permeability is lowered, which is not appropriate, and adhesive force to porous substrates may decrease. Additionally, if the polyethylene particles are used in too small a quantity, the safety effect resulting from the use of the polyethylene particles may not be sufficiently obtained. That is, if using a small amount of polyethylene particles, for example, the same amount of polyethylene particles and the first ceramic, the coating layer should be formed very thick so as to obtain the effect of using the polyethylene particles. In this case, the separator becomes too thick, and thus it deviates from typical battery specifications, making it difficult to actually use it for battery manufacturing. If a normal-sized battery is manufactured using this separator, the size of the positive electrode or negative electrode should be reduced, which may result in lower capacity. Alternatively, if a battery is fabricated using a conventional positive electrode and negative electrode using this separator, the final battery thickness increases too excessively, making it difficult to use in practice.

The polyethylene particles are polymer particles having a melting temperature of 80° C. to 130° C. and may be in a wax form. At this time, the wax form, that is, polyethylene wax, means that the molecular weight is larger than that of an oligomer and smaller than that of a polymer, and for example, the weight average molecular weight (Mw) may be 1000 g/mol to 5000 g/mol, 1000 g/mol to 5000 g/mol, or 1500 g/mol to 3000 g/mol.

The polyethylene particles do not melt during normal charging and discharging within the battery, but if a high temperature phenomenon occurs within the battery, it melts before the porous substrate above the melting temperature and block the pores within the porous substrate to block the movement of ions, induces a quick shutdown function, and ensures the safety of the rechargeable battery. An average size of the polyethylene particles may be 0.1 μm to 3.0 μm. Specifically, the average size of the polyethylene particles may be greater than or equal to 0.1 μm and less than or equal to 2.0 μm, greater than or equal to 0.5 μm and less than or equal to 2.0 μm, for example, greater than or equal to 0.5 μm and less than or equal to 1.5 μm, or greater than or equal to 1.0 μm and less than or equal to 1.5 μm.

The coating layer may further include an aqueous binder, for example, a vinyl group-containing binder. In this specification, ‘(meth)acrylic’ means acrylic or methacrylic.

The vinyl group-containing binder may include a (meth)acrylic copolymer including a first structural unit derived from (meth)acrylamide, and a second structural unit including at least one of a structural unit derived from (meth)acrylic acid, (meth)acrylate, (meth)acrylonitrile, or a combination thereof, and a structural unit derived from (meth)acrylamidosulfonic acid, a (meth)acrylamidosulfonate salt, or a combination thereof.

The first structural unit derived from (meth)acrylamide includes an amide functional group (—NH₂) within the structural unit. The —NH₂ functional group may improve adhesion characteristics with the porous substrate and electrode, and may more firmly fix the first inorganic particles in the coating layer by forming a hydrogen bond with the —OH functional group of the first inorganic particles, which will be described later. Accordingly, the heat resistance of the separator may be strengthened.

The structural unit derived from (meth)acrylic acid, (meth)acrylate, (meth)acrylonitrile, or a combination thereof included in the second structural unit is used to fix the polyethylene particles and the first ceramic particles on the porous substrate and at the same time, it may provide an adhesive force so that the coating layer adheres well to the porous substrate and electrode, and may contribute to improving the heat resistance and air permeability of the separator. In addition, by including a carboxyl functional group (—C(═O)O—) in the structural unit, dispersibility of the coating slurry may be improved, and by including a nitrile group, oxidation resistance of the separator may be improved and the moisture content may be reduced.

In addition, the structural unit derived from (meth)acrylamidosulfonic acid, (meth)acrylamidosulfonic acid salt, or a combination thereof included in the second structural unit includes a bulky functional group, thereby reducing mobility of the copolymer including it and thus strengthening heat resistance of the separator.

The vinyl group-containing binder includes a vinyl group-containing copolymer having a glass transition temperature (Tg) of greater than or equal to 150° C., so heat resistance can be further improved. Therefore, it may be included in the coating layer together with the first inorganic particles and polyethylene particles to exhibit excellent heat resistance and air permeability of the separator for rechargeable lithium batteries.

The adhesive layer may include a second ceramic and a binder in a weight ratio of 7:3 to 5:5. In the adhesive layer, if the weight ratio of the second ceramic and the binder is outside the above range, for example, if the binder is used in an excessive amount, the air permeability may increase too much, resulting in an increase in battery resistance, and if a smaller amount of binder is used, the adhesive force to the electrode may decrease.

In an embodiment, the binder may include a polyvinylidene fluoride (PVdF) and polyvinylidene-hexapropylene (PVdF-HFP) copolymer, and in particular, polyvinylidene fluoride (PVdF) and polyvinylidene-hexapropylene (PVdF-HFP) copolymer may be included in a weight ratio of 6:4 to 4:6. If the weight ratio of PVdF and PVdF-HFP as a binder included in the adhesive layer is outside the above range, both the adhesive force to the electrode and the air permeability are reduced, which is not appropriate. As such, the adhesive layer includes an organic binder, and in an embodiment, as the adhesive layer includes an organic binder, an adhesive force to the electrode can be further improved. In particular, both dry adhesive force and wet adhesive force may be improved. Therefore, the separator according to an embodiment is suitable as it may satisfy both the dry adhesive force and the wet adhesive force required as the type of rechargeable lithium battery is changed from the conventional wound type to the recent stacked type.

This adhesion improvement effect of dry adhesive force and wet adhesive force may not be obtained if using an aqueous binder, and especially even if an organic binder is used, it may be not obtained if polyvinylidene fluoride (PVdF) and polyvinylidene-hexapropylene (PVdF-HFP) copolymers are used under conditions exceeding the weight ratio of 6:4 to 4:6.

In an embodiment, the dry adhesive force refers to an adhesive force between the separator and the active material layer that occurs if heat and pressure are applied to the electrode assembly (wound type or stacked type, regardless of shape) of the positive electrode, separator, and negative electrode. The wet dry adhesive force refers to an adhesive force between the separator and the active material layer that occurs if heat and pressure are applied after electrolyte is injected into the electrode assembly.

The adhesive force between the separator and the active material layer should be maintained at an appropriate level, so that after manufacturing the electrode assembly, if moving the electrode assembly for subsequent battery fabricating processes such as electrolyte injection, it may be moved with the separator and active material layer attached, but if the adhesive force is too low, the problem of separation of the separator and the active material layer may occur, especially in the stacked type. In addition, if appropriate wet adhesive force is not maintained during formation charging and discharging of the final battery after performing processes such as electrolyte, a deformation phenomenon in which the battery swells may occur. Accordingly, for battery application, the dry adhesive force must satisfy 90N or more and the wet adhesive force must satisfy 600N or more, and the separator of an embodiment is suitable as it may satisfy these physical properties.

Additionally, the average sizes of the first ceramic and the second ceramic may be different. In an embodiment, the average size of the first ceramic may be larger than the average size of the second ceramic.

If the average size of the first ceramic is larger than the average size of the second ceramic, the effect of using polyethylene particles in the coating layer may be more fully obtained and better cycle-life characteristics may be obtained.

If the average size of the first ceramic is smaller than the average size of the second ceramic, that is, if the second ceramic is used larger than the first ceramic, the use of an excessive amount of binder is required, and accordingly there may be problems in that the thickness of the adhesive layer increases, resistance increases, the cycle-life may decrease, and the energy density decreases.

An average size of the first ceramic may be 550 nm to 750 nm, 600 nm to 750 nm, or 600 nm to 700 nm. If the average size of the first ceramic is within the above range, cycle-life characteristics may be improved due to appropriate air permeability, for example, 240 sec/100 cc or less and excellent binding force to a porous substrate. The lower air permeability of the separator, the better, and it is appropriate if it is less than 240 sec/100 cc.

Additionally, the average size of the second ceramic may be 200 nm to 300 nm, or 230 nm to 270 nm. If the average size of the second ceramic is within the above range, an appropriate specific surface area may be maintained, the binder effect may be properly maintained, and the adhesive layer may be formed with an appropriate thickness. If an excessively large second ceramic is used, for example, larger than the above average size, it is not appropriate because the thickness of the adhesive layer may be excessively increased. In an embodiment, the size ratio of the first ceramic and the second ceramic may be 5:1 to 1.5:1, 4:1 to 1.5:1, or 3.75:1 to 1.8:1.

The first ceramic or the second ceramic may be the same or different from each other, and may include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof. In an embodiment, the first ceramic may be boehmite, and the second ceramic may be Al₂O₃.

In addition, the ceramic may be cubic, plate-shaped, spherical, or irregular, and its shape does not need to be limited.

The porous substrate has a large number of pores and may be a substrate commonly used in batteries. The porous substrate may include any one selected from polyolefin such as polyethylene and polypropylene, polyester such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, polyethylenenaphthalate, a glass fiber, TEFLON (tetrafluoroethylene), and polytetrafluoroethylene, or a copolymer or mixture of two or more types thereof.

In an embodiment, the porous substrate may include polyolefin. The porous substrate including polyolefin may include, for example, a polyethylene single film, a polypropylene single film, a polyethylene/polypropylene double film, a polypropylene/polyethylene/polypropylene triple film, or a polyethylene/polypropylene/polyethylene triple film.

A thickness of the single layer of the coating layer may be 0.5 μm to 5 μm, for example 1 μm to 5 μm, 1 μm to 4 μm, 1 μm to 3 μm, or 1 μm to 2 μm. In an embodiment, the thickness of the coating layer is not limited to this and can be appropriately adjusted depending on the thickness, weight, porosity, etc. of the porous substrate.

A thickness of the single layer of the adhesive layer may be 0.1 μm to 4.0 μm, for example, 0.1 μm to 3.0 μm, 0.1 μm to 2.0 μm, or 0.1 μm to 1.0 μm. Additionally, according to an embodiment, for example, it may be 0.3 μm to 1.0 μm, 0.4 μm to 1.0 μm, 0.4 μm to 0.9 μm, or 0.5 μm to 0.9 μm. If the thickness of the adhesive layer is within the above range, excellent cycle-life, dry adhesive force, and wet adhesive force may be exhibited.

The porous substrate may have a thickness of 1 μm to 40 μm, for example 1 μm to 30 μm, 1 μm to 20 μm, 5 μm to 15 μm, or 5 μm to 10 μm.

As such, the separator according to an embodiment includes a coating layer including the polyethylene particles and first ceramic at a specific weight ratio, the second ceramic and binder at a specific weight ratio, the binder includes the polyvinylidene fluoride and polyvinylidene-hexapropylene copolymer at a specific weight ratio, and the first ceramic and the second ceramic may have different average sizes. A separator with this combination has excellent adhesive force to the electrode and also has excellent air permeability, allowing lithium movement to occur easily.

A separator for a rechargeable lithium battery according to an embodiment may be manufactured by various known methods. For example, in a separator for a rechargeable lithium battery, a coating layer forming composition is coated on one or both surfaces of a porous substrate and then dried to form a coating layer, and the composition for forming an adhesive layer may be coated on one surface of the coating layer and then dried to form an adhesive layer.

The composition for forming the coating layer may include first inorganic particles, polyethylene particles, and a solvent, and may further include a vinyl group-containing binder. The solvent is not particularly limited as long as it can dissolve or disperse the first inorganic particles, the polyethylene particles, and the vinyl group-containing binder. In an embodiment, the solvent may be an aqueous solvent including water, alcohol, or a combination thereof. The alcohol may be methyl alcohol, ethyl alcohol, propyl alcohol, or a combination thereof.

The coating may be performed by, for example, gravure coating, spin coating, dip coating, bar coating, die coating, slit coating, roll coating, inkjet printing, etc., but is not limited thereto.

The drying may be performed by, for example, natural drying, drying with warm air, hot air or low humidity air, vacuum drying, irradiation with far-infrared rays, electron beams, etc., but is not limited thereto. The drying process may be performed at a temperature of, for example, 25° C. to 120° C.

The composition for forming the adhesive layer may include a second ceramic, a binder, and a solvent. The solvent may be an aqueous solvent including water, alcohol, or a combination thereof. The alcohol may be methyl alcohol, ethyl alcohol, propyl alcohol, or a combination thereof.

Another embodiment provides a rechargeable lithium battery including a negative electrode, a positive electrode, a separator between the negative electrode and the positive electrode, and an electrolyte.

The separator is a separator according to an embodiment.

The negative electrode includes a current collector and a negative electrode active material layer formed on the current collector and including the negative electrode active material.

The negative electrode active material may be a material that reversibly intercalates/deintercalates lithium ions, a lithium metal, a lithium metal alloy, a material capable of doping/dedoping lithium, or a transition metal oxide.

Examples of the material that reversibly intercalates/deintercalates lithium ions include a carbon material, that is, a carbonaceous negative electrode active material commonly used in rechargeable lithium batteries. Representative examples of carbonaceous negative electrode active materials include crystalline carbon, amorphous carbon, or a combination thereof.

Examples of the crystalline carbon may include graphite such as unspecific-shaped, plate-shaped, flake-shaped, spherical-shaped or fibrous-shaped natural graphite or artificial graphite, and examples of the amorphous carbon may include soft carbon or hard carbon, mesophase pitch carbonized product, calcined coke, etc.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, SiOx (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), a Si-carbon composite, Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn), a Sn-carbon composite, and the like, and additionally, at least one of these may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof.

The titanium metal oxide may be lithium titanium oxide.

The negative electrode active material according to an embodiment may include a Si—C composite including a Si-included active material and a carbonaceous active material.

The Si-included active material may be Si, SiOx (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), or a combination thereof.

An average particle diameter of the Si-included active material may be 50 nm to 200 nm.

If the average particle diameter of the Si-included active material is within the above range, volume expansion that occurs during charging and discharging may be suppressed, and disconnection of the conductive path due to particle crushing during charging and discharging may be prevented.

The Si-included active material may be included in an amount of 1 wt % to 60 wt %, for example 3 wt % to 60 wt %, based on a total weight of the Si—C composite.

The negative electrode active material according to another embodiment may further include crystalline carbon along with the Si—C composite described above.

If the negative active material includes a Si—C composite and crystalline carbon, the Si—C composite and crystalline carbon may be included in the form of a mixture, and in this case, the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, may include natural graphite, artificial graphite, or a mixture thereof.

An average particle diameter of the crystalline carbon may be 5 μm to 30 μm.

In this specification, the average particle diameter may be the particle size (D50) at 50 volume % in the cumulative size-distribution curve. The average particle size (D50) can be measured by methods well known to those skilled in the art, for example, using a particle size analyzer, a transmission electron microscope photograph, or a scanning electron microscope. Alternatively, a dynamic light-scattering measurement device is used to perform a data analysis, and the number of particles is counted for each particle size range, and from this, the average particle diameter (D50) value may be easily obtained through a calculation.

The Si—C composite may further include a shell surrounding the surface of the Si—C composite, and the shell may include amorphous carbon. The thickness of the shell may be 5 nm to 100 nm.

The amorphous carbon may include soft carbon, hard carbon, mesophase pitch carbide, calcined coke, or mixtures thereof.

The amorphous carbon may be included in an amount of 1 to 50 parts by weight, for example, 5 to 50 parts by weight, or 10 to 50 parts by weight, based on 100 parts by weight of the carbon-based active material.

If using the Si—C composite as a negative electrode active material, a problem of increased resistance may occur but, if used together with an electrolyte including the additive of Chemical Formula 1 according to an embodiment, the increase in resistance can be more effectively suppressed.

The negative electrode active material layer includes a negative electrode active material and a binder, and may optionally further include a conductive material.

In the negative electrode active material layer, the negative electrode active material may be included in an amount of 95 wt % to 99 wt % based on the total weight of the negative electrode active material layer. An amount of the binder in the negative electrode active material layer may be 1 wt % to 5 wt % based on a total weight of the negative electrode active material layer. In addition, if a conductive material is further included, 90 wt % to 98 wt % of the negative electrode active material, 1 wt % to 5 wt % of the binder, and 1 wt % to 5 wt % of the conductive material may be used.

The binder serves to well attach the negative electrode active material particles to each other and also to well attach the negative electrode active material to the current collector. The binder may be a non-water-soluble binder, a water-soluble binder, or a combination thereof.

The non-water-soluble binder may be an ethylenepropylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, an acrylonitrile-butadiene rubber, an acrylic rubber, butyl rubber, a fluoro rubber, an ethylene oxide-containing polymer, polyvinylpyrrolidone, polyepichlorohydrin, polyphosphazene, ethylenepropylenediene copolymer, polyvinylpyridine, chlorosulfonatedpolyethylene, latex, a polyester resin, an acrylic resin, phenolic resin, an epoxy resin, polyvinyl alcohol, or a combination thereof.

If a water-soluble binder is used as the negative electrode binder, a cellulose compound capable of imparting viscosity may be further included as a thickener. The cellulose compound may include one or more types of carboxymethyl cellulose, hydroxypropylmethyl cellulose, methyl cellulose, or alkali metal salts thereof. The alkali metal may be Na, K, or Li. An amount of the thickener used may be 0.1 to 3 parts by weight based on 100 parts by weight of the negative electrode active material.

The conductive material is used to impart conductivity to the electrode, and any material may be used as long as it does not cause chemical change in the battery to be configured and is an electron conductive material. Examples of the conductive material may be a carbon-based material such as natural graphite, artificial graphite, carbon black, acetylene black, ketjen black, denka black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The positive electrode includes a current collector and a positive electrode active material layer formed on the current collector and including a positive electrode active material. The positive electrode active material may include lithiated intercalation compounds that reversibly intercalate and deintercalate lithium ions, specifically one or more composite oxides of a metal selected from cobalt, manganese, nickel, and a combination thereof, and lithium. As a more specific example, a compound represented by any one of the following chemical formulas may be used. LiₐA_{1-b}X_{b}D₂ (0.90≤a≤1.8, 0≤b≤ 0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤ 0.5, 0≤c≤0.05); LiₐNi_{1-b-c}CO_{b}X_{c}Dₐ (0.90≤a≤1.8, 0≤b≤0.5, 0≤c≤0.5, 0<a≤2); LiₐNi_{1-b-c}CO_{b}X_{c}O₂₋ₐTₐ (0.90≤a≤1.8, 0≤b≤0.5, 0≤c≤0.5, 0<a<2); LiₐNi_{1-b-c}CO_{b}X_{c}O₂₋ₐT₂ (0.90≤a≤1.8, 0≤b≤0.5, 0≤c≤0.5, 0<a<2); LiₐNi_{1-b-c}Mn_{b}X_{c}Dₐ (0.90≤a≤1.8, 0≤b≤0.5, 0≤c≤0.5, 0<a≤2); LiₐNi_{1-b-c}Mn_{b}X_{c}O₂₋ₐTₐ (0.90<a≤ 1.8, 0<b≤ 0.5, 0<<<0.5, 0<<<2); LiₐNi_{1-b-c}Mn_{b}X_{c}O₂₋ₐT₂ (0.90≤a≤1.8, 0≤b≤0.5, 0≤c≤0.5, 0<a<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}G_{d}O₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound. For example, the method may include any coating method (e.g., spray coating, dipping, etc.), but is not illustrated in more detail since it is well-known to those skilled in the related field.

In the positive electrode, an amount of the positive electrode active material may be 90 wt % to 98 wt % based on a total weight of the positive electrode active material layer.

In an embodiment, the positive electrode active material layer may further include a binder and a conductive material. At this time, each amount of the binder and the conductive material may each be 1 wt % to 5 wt % based on a total weight of the positive electrode active material layer.

The binder serves to well attach the positive electrode active material particles to each other and also to well attach the positive electrode active material to the current collector, and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be aluminum foil, nickel foil, or a combination thereof, but is not limited thereto.

The positive electrode active material layer and the negative electrode active material layer are formed by mixing an active material, a binder, and optionally a conductive material in a solvent to prepare an active material composition, and coating this active material composition on a current collector. This method of forming an active material layer is widely known in the art and thus detailed description will be omitted in this specification. The solvent includes N-methylpyrrolidone and the like, but is not limited thereto. Additionally, if an aqueous binder is used in the negative electrode active material layer, water may be used as a solvent used in preparing the negative electrode active material composition.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methyl propionate, ethyl propionate, propyl propionate, decanolide, mevalonolactone, caprolactone, and the like

The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The non-aqueous organic solvents may be used alone or in combination with one or more. If the organic solvent is used in a mixture, the mixture ratio may be controlled in accordance with a desirable battery performance.

The carbonate-based solvent is prepared by mixing a cyclic carbonate and a chain carbonate. In this case, a mixture of cyclic carbonate and chain carbonate in a volume ratio of 1:1 to 1:9 may result in superior electrolyte performance.

If the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may be methyl propionate, ethyl propionate, propyl propionate, or a combination thereof.

Herein, if the cyclic carbonate and the chain carbonate or the cyclic carbonate and the propionate-based solvent are mixed, they may be mixed in a volume ratio of 1:1 to 1:9 and thus performance of an electrolyte may be improved. In addition, if the cyclic carbonate, the chain carbonate, and the propionate-based solvent are mixed, they may be mixed in a volume ratio of 1:1:1 to 3:3:4. The mixing ratios of the solvents may be appropriately adjusted according to desirable properties.

The non-aqueous organic solvent of the present disclosure may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 2.

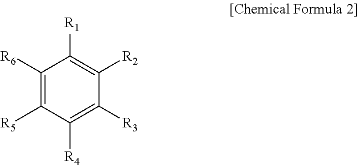

In Chemical Formula 2, R₁ to R₆ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive of vinylene carbonate, or an ethylene carbonate-based compound of Chemical Formula 3 as a cycle-life enhancing additive.

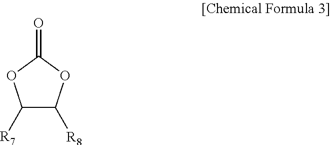

In Chemical Formula 3, R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₈ are not hydrogen.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. If using more of these cycle-life enhancing additives, the amount used can be adjusted appropriately.

The electrolyte may further include vinylethylene carbonate, propane sultone, succinonitrile, or a combination thereof, and the use amount may be adjusted appropriately.

The lithium salt dissolved in an organic solvent supplies a battery with lithium ions, basically operates the rechargeable lithium battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiPO₂F₂, LiN(CₓF₂ₓ₊₁SO₂) (C_{y}F_{2y+1}SO₂) where x and y are natural numbers, for example integers of 1 to 20, lithium difluoro (bisoxalato) phosphate, LiCl, Lil, LiB(C₂O₄)₂ (lithium bis(oxalato) borate: LiBOB), and lithium difluoro (oxalato) borate (LiDFOB), as a supporting electrolytic salt. A concentration of the lithium salt may range from 0.1 M to 2.0 M. If the lithium salt is included at the above concentration range, an electrolyte may have excellent performance and lithium ion mobility due to optimal electrolyte conductivity and viscosity.

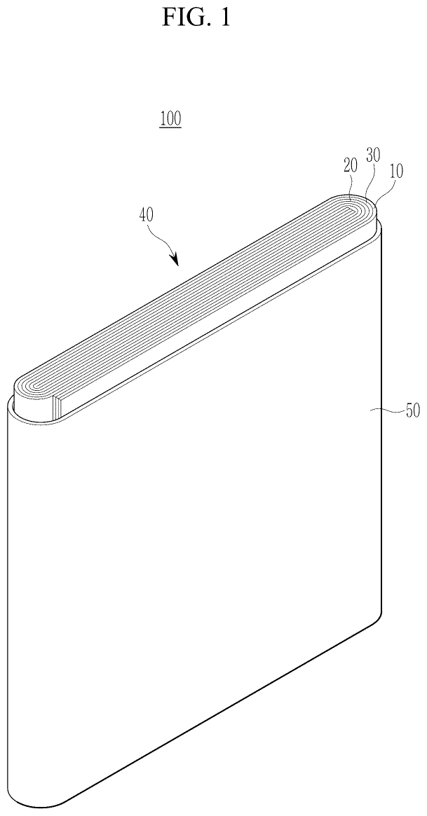

FIG. 1 shows an exploded perspective view of a rechargeable lithium battery according to an embodiment of the present invention. Although the rechargeable lithium battery according to an embodiment is described as an example of a prismatic shape, the present invention is not limited thereto and can be applied to batteries of various shapes, such as cylindrical and pouch types.

Referring to FIG. 1, a rechargeable lithium battery according to an embodiment may include an electrode assembly 40 manufactured by winding a separator 30 disposed between a positive electrode 10 and a negative electrode 20 and a case 50 housing the electrode assembly 40. An electrolyte (not shown) may be impregnated in the positive electrode 10, the negative electrode 20 and the separator 30.

### MODE FOR PERFORMING THE INVENTION

Hereinafter, examples of the present invention and comparative examples are described. These examples, however, are not in any sense to be interpreted as limiting the scope of the invention.

### Example 1

### 1. Manufacture of Separator

### 1) Formation of Coating Layer

A composition for forming a coating layer was prepared by mixing polyethylene wax with an average size (D50) of 1 μm (a melting temperature: 110° C., a weight average molecular weight (Mw): 1500 g/mol), boehmite with an average size (D50) of 650 nm, and a methacryl-based copolymer binder including a first structural unit derived from methacrylacrylamide and a second structural unit derived from methacrylic acid in a weight ratio of 56.7:37.8:5.5 in a water solvent. In other words, the polyethylene wax and the boehmite were mixed in a weight ratio of 6:4.

The prepared composition for forming a coating layer was coated on both surfaces of a 7 μm-thick polyethylene single layer substrate in a gravure coating method and then, dried at 60° C. to form a coating layer with a one surface coating thickness of 2 μm.

### 2) Formation of Adhesive Layer

A composition for forming an adhesive layer was prepared by mixing Al₂O₃ with an average size (D50) of 250 nm and a binder of polyvinylidene fluoride (PVdF) and polyvinylidene fluoride-hexafluoropropylene (PVdF-HFP) copolymers (PVdF:PVdF-HFP=5:5 in a weight ratio) in a weight ratio of 6:4 in an N-methyl pyrrolidone solvent.

The composition for forming an adhesive layer was respectively coated on the coating layers in a gravure coating method and then, dried at 70° C. to form an adhesive layer with an one surface thickness of 0.7 μm. As a result, the obtained separator had a five-layer structure of the porous substrate, the coating layers formed on both sides of the porous substrate, and the adhesive layers respectively formed on the coating layers.

### (Examples 2 to 4, Comparative Examples 1 to 12, and Reference Examples 1 to 13

Separators were respectively manufactured in the same manner as in Example 1 except that the weight ratio of polyethylene wax and boehmite and the boehmite average size in the composition for forming a coating layer and the weight ratio of Al₂O₃ and the binder, the average size of Al₂O₃, and the weight ratio of PVdF:PVdF-HFP in the composition for forming an adhesive layer were changed as shown in Table 1.

TABLE 1

| | Coating layer | | Adhesive layer | | |
|---|---|---|---|---|---|
| | PE wax: | boehmite | Al₂O₃: | Al₂O₃ | PVdF: |
| | boehmite | average | binder | average | PVdF-HFP |
| | (weight | size | (weight | size | (weight |
| | ratio) | (D50, nm) | ratio) | (D50, nm) | ratio) |
| Example 1 | 6:4 | 650 | 6:4 | 250 | 5:5 |
| Example 2 | 8:2 | 650 | 6:4 | 250 | 5:5 |
| Example 3 | 6:4 | 650 | 5:5 | 250 | 5:5 |
| Example 4 | 8:2 | 650 | 5:5 | 250 | 5:5 |
| Comparative | 6:4 | 250 | 6:4 | 250 | 5:5 |
| Example 1 | | | | | |
| Comparative | 8:2 | 250 | 6:4 | 250 | 5:5 |
| Example 2 | | | | | |
| Comparative | 6:4 | 250 | 5:5 | 250 | 5:5 |
| Example 3 | | | | | |
| Comparative | 8:2 | 250 | 5:5 | 250 | 5:5 |
| Example 4 | | | | | |
| Comparative | 6:4 | 650 | 8:2 | 250 | 5:5 |
| Example 5 | | | | | |
| Comparative | 8:2 | 650 | 8:2 | 250 | 5:5 |
| Example 6 | | | | | |
| Comparative | 6:4 | 650 | 8:2 | 200 | 5:5 |
| Example 7 | | | | | |
| Comparative | 8:2 | 650 | 8:2 | 200 | 5:5 |
| Example 8 | | | | | |
| Comparative | 6:4 | 650 | 8:2 | 250 | 4:6 |
| Example 9 | | | | | |
| Comparative | 6:4 | 650 | 8:2 | 250 | 6:4 |
| Example 10 | | | | | |
| Comparative | 5:5 | 650 | 6:4 | 250 | 5:5 |
| Example 11 | | | | | |
| Comparative | 9:1 | 650 | 6:4 | 250 | 5:5 |
| Example 12 | | | | | |
| Reference | 6:4 | 900 | 6:4 | 250 | 5:5 |
| Example 1 | | | | | |
| Reference | 8:2 | 900 | 6:4 | 250 | 5:5 |
| Example 2 | | | | | |
| Reference | 6:4 | 900 | 5:5 | 250 | 5:5 |
| Example 3 | | | | | |
| Reference | 8:2 | 900 | 5:5 | 250 | 5:5 |
| Example 4 | | | | | |
| Reference | 6:4 | 900 | 5:5 | 100 | 5:5 |
| Example 5 | | | | | |
| Reference | 6:4 | 900 | 5:5 | 310 | 5:5 |
| Example 6 | | | | | |
| Reference | 8:2 | 900 | 5:5 | 100 | 5:5 |
| Example 7 | | | | | |
| Reference | 8:2 | 900 | 5:5 | 310 | 5:5 |
| Example 8 | | | | | |
| Reference | 6:4 | 900 | 5:5 | 250 | 3:7 |
| Example 9 | | | | | |
| Reference | 6:4 | 900 | 5:5 | 250 | 7:3 |
| Example 10 | | | | | |
| Reference | 8:2 | 900 | 5:5 | 250 | 3:7 |
| Example 11 | | | | | |
| Reference | 8:2 | 900 | 5:5 | 250 | 7:3 |
| Example 12 | | | | | |
| Reference | 6:4 | 250 | 6:4 | 650 | 5:5 |
| Example 13 | | | | | |

### Experimental Example 1: Air Permeability

During the manufacturing processes of Examples 1 to 4, Comparative Examples 1 to 12, and Reference Examples 1 to 13, a porous substrate with each coating layer formed on was measured with respect to air permeability, and the results are shown as air permeability of coating layers in Table 2. The air permeability experiment was performed by using an air permeability meter (TYPE EG01-55-1MR, ASAHI-SEICO Co., Ltd.) to measure time (seconds) that it took for 100 cc of air to pass each separator.

In addition, the separators according to Examples 1 to 4, Comparative Examples 1 to 12, and Reference Example 1 to 13 were respectively measured with respect to air permeability in the same manner as above. The results are shown in Table 2.

### Experimental Example 2: Binding Force

During the manufacturing processes of Examples 1 to 4, Comparative Examples 1 and 12, and Reference Examples 1 to 13, a porous substrate with each coating layer formed on was cut into a width of 12 mm and a length of 50 mm to prepare samples. After attaching a tape adhered to a slide glass to the adhesive layer side of each of the samples, the tape and the adhesive layer were peeled off by using a 180 [symbol] UTM tensile strength tester to measure a binding force. Herein, a peeling speed was set at 10 mm/min, and the binding force was obtained by 3 times repeating the measurement and averaging them to obtain a force required for 40 mm peeling. The results are shown as coating layer results in Table 2.

### Experimental Example 3: Dry Adhesive Force and Wet Adhesive Force

Each of the separators of Examples 1 to 4, Comparative Examples 1 to 12, and Reference Examples 1 to 12 was cut to prepare two sheets with a size of 1 cm×8 cm, and two sheets of each positive electrode with a size of 3.4 cm×8 cm were prepared. The prepared positive electrode, separator, separator, and positive electrode in order were stacked, and this stack was placed into a pouch with a size of 10 cm×20 cm, primarily pressed at 75° C. under a pressure of 6.84 kgf/cm² for 40 seconds, and subsequently secondarily pressed at 75° C. under a pressure of 11.4 kgf/cm² for 15 seconds, preparing samples. Herein, the positive electrode was manufactured by mixing 94 wt % of LiCoO₂, 3 wt % of ketjen black, and 3 wt % of polyvinylidene fluoride in an N-methyl pyrrolidone solvent to prepare a positive electrode active material layer composition, coating the positive electrode active material layer composition on a copper current collector, and then, drying and pressurizing it. In the stacking process, the adhesive layer of each separator was positioned to contact the positive electrode active material layer.

The samples were measured with respect to a dry adhesive force in the same manner as in the binding force experiment. The results are shown in Table 2.

The separators of Examples 1 to 4, Comparative Examples 1 to 12, and Reference Examples 1 to 13 were respectively cut into two sheets respectively with a size of 1 cm×8 cm, and two sheets of each positive electrode with a size of 3.4 cm×8 cm were prepared. The prepared positive electrode, separator, separator, and positive electrode in order were stacked, and this stack was placed into a pouch with a size of 10 cm×20 cm, and 0.4 g of an electrolyte was added to this pouch. Subsequently, the pouch was pressed at 60° C. under a pressure of 11.4 kgf/cm² for 60 minutes, preparing a sample.

The sample was used to measure a wet adhesive force in the same manner in the binding force experiment. The results are shown in Table 2.

TABLE 2

| | Coating layer | | Separator | | |
|---|---|---|---|---|---|
| | | | Dry | Wet a | |
| | Air | Binding | adhesive | dhesive | Air |
| | permeability | force | force | force | permeability |
| | (sec/100 cc) | (N) | (N) | (N) | (sec/100 cc) |
| Example 1 | 171 | 0.72 | 98 | 612 | 215 |
| Example 2 | 183 | 0.55 | 96 | 600 | 220 |
| Example 3 | 171 | 0.72 | 102 | 630 | 225 |
| Example 4 | 183 | 0.55 | 98 | 605 | 236 |
| Comparative | 210 | 0.61 | 98 | 610 | 274 |
| Example 1 | | | | | |
| Comparative | 220 | 0.59 | 96 | 605 | 288 |
| Example 2 | | | | | |
| Comparative | 210 | 0.61 | 100 | 601 | 286 |
| Example 3 | | | | | |
| Comparative | 220 | 0.59 | 103 | 604 | 290 |
| Example 4 | | | | | |
| Comparative | 171 | 0.72 | 80 | 450 | 219 |
| Example 5 | | | | | |
| Comparative | 183 | 0.55 | 54 | 380 | 224 |
| Example 6 | | | | | |
| Comparative | 171 | 0.72 | 60 | 433 | 235 |
| Example 7 | | | | | |
| Comparative | 183 | 0.55 | 52 | 377 | 240 |
| Example 8 | | | | | |
| Comparative | 171 | 0.72 | 66 | 534 | 206 |
| Example 9 | | | | | |
| Comparative | 171 | 0.72 | 88 | 420 | 204 |
| Example 10 | | | | | |
| Comparative | 160 | 0.75 | 107 | 654 | 199 |
| Example 11 | | | | | |
| Comparative | — | — | — | — | — |
| Example 12 | | | | | |
| Reference | 156 | 0.4 | 84 | 465 | 194 |
| Example 1 | | | | | |
| Reference | 161 | 0.36 | 79 | 442 | 200 |
| Example 2 | | | | | |
| Reference | 156 | 0.4 | 88 | 478 | 181 |
| Example 3 | | | | | |
| Reference | 161 | 0.36 | 80 | 470 | 188 |
| Example 4 | | | | | |
| Reference | 156 | 0.4 | 74 | 393 | 203 |
| Example 5 | | | | | |
| Reference | 156 | 0.4 | 83 | 494 | 176 |
| Example 6 | | | | | |
| Reference | 161 | 0.36 | 70 | 380 | 190 |
| Example 7 | | | | | |
| Reference | 161 | 0.36 | 83 | 486 | 171 |
| Example 8 | | | | | |
| Reference | 156 | 0.4 | 43 | 846 | 186 |
| Example 9 | | | | | |
| Reference | 156 | 0.4 | 116 | 299 | 184 |
| Example 10 | | | | | |
| Reference | 161 | 0.36 | 40 | 812 | 196 |
| Example 11 | | | | | |
| Reference | 161 | 0.36 | 105 | 280 | 195 |
| Example 12 | | | | | |
| Reference | 210 | 0.61 | 115 | 694 | 243 |
| Example 13 | | | | | |

As shown in Table 2, in Examples 1 to 4, in which each coating layer included polyethylene wax and boehmite in a weight ratio of 6:4 to 8:2, and each adhesive layer included Al₂O₃ and a binder (PVdF and PVdF-HFP) in a weight ratio of 6:4 to 8:2, wherein the boehmite had a larger average size than Al₂O₃, and PVdF and PVdF-HFP were included in a weight ratio of 6:4 to 4:6, the coating layer exhibited an excellent binding force, and each final separator exhibited excellent dry and wet adhesive forces. In addition, Examples 1 to 4 exhibited air permeability of 240 sec/100 or less, which confirmed excellent air permeability characteristics.

Comparative Examples 1 to 4, of which each adhesive layer included Al₂O₃ and a binder (PVdF and PVdF-HFP), and the boehmite and Al₂O₃ had the same average size, exhibited excellent dry and wet adhesive forces. However, Comparative Examples 1 to 4 had air permeability of greater than 240 sec/100 cc, which confirmed deteriorated air permeability characteristics.

On the contrary, Comparative Examples 5 to 10, of which each adhesive layer included alumina and a PVdF binder in a weight ratio of 8:2, exhibited dry and wet adhesive forces not satisfying each reference of 90N or more and 600N or more.

In addition, in Comparative Example 11, whose coating layer included polyethylene wax and boehmite in a weight ratio of 5:5, the polyethylene wax was included in too small a content to well form the coating layer.

In Comparative Example 12, in which a composition for a coating layer included polyethylene wax and boehmite in a weight ratio of 9:1, wherein ceramic, that is, boehmite was included in too small a content to be coated, property experiments could not be performed.

Reference Examples 1 to 12, in which each coating layer included polyethylene wax and boehmite in a weight ratio of 6:4 to 8:2, and each adhesive layer included Al₂O₃ and a binder (PVdF and PVdF-HFP) in a weight ratio of 6:4 to 8:2, wherein even if PVdF and PVdF-HFP were included in a weight ratio of 6:4 to 4:6, the boehmite had a large average size of 900 μm, exhibited a very low binding force to a porous substrate and also, did not satisfy both dry and wet adhesive force reference or either one of dry or wet adhesive force reference.

Reference Example 13, in which the coating layer included polyethylene wax and boehmite in a weight ratio of 6:4 to 8:2, and the adhesive layer included Al₂O₃ and a binder (PVdF and PVdF-HFP) in a weight ratio of 6:4 to 8:2, wherein even if PVdF and PVdF-HFP were included in a weight ratio of 6:4 to 4:6, the boehmite had a smaller average size than Al₂O₃, exhibited too high air permeability of 243 sec/100 cc.

As shown in Table 2, Comparative Examples 5 to 10 and Reference Examples 1 to 9 and 11, in which dry adhesive force of less than 90N or wet adhesive force of less than 600N were obtained, could not be used to manufacture battery cells, and thus subsequent experiments were not conducted. In addition, because Reference Example 13 exhibited too high air permeability, subsequent experiments were not conducted.

### Experimental Example 4) Capacity Retention

The separators of Examples 1 to 4, Comparative Examples 1 to 4 and 11, and Reference Examples 10 and 12 were respectively used with a negative electrode, a positive electrode, and an electrolyte to fabricate rechargeable lithium battery cells in a common method.

The negative electrode was manufactured by mixing 94 wt % of artificial graphite, 3 wt % of ketjen black, and 3 wt % of polyvinylidene fluoride in an N-methyl pyrrolidone solvent to prepare a negative electrode active material layer composition, coating the negative electrode active material layer composition on a copper current collector, and then, drying and pressurizing it.

The positive electrode was manufactured by mixing 94 wt % of LiCoO₂, 3 wt % of ketjen black, and 3 wt % of polyvinylidene fluoride in an N-methyl pyrrolidone solvent to prepare a positive electrode active material layer composition, coating the positive electrode active material layer composition on a copper current collector, and drying and pressurizing it.

The electrolyte was prepared by dissolving 1.5 M LiPF₆ in a mixed solvent of ethylene carbonate, ethylmethyl carbonate, and dimethyl carbonate (in a volume ratio of 2:1:7).

The fabricated battery cells were 100 times charged and discharged at 1.3 C at 23° C. to obtain a ratio of 100^{th} charge capacity to 1^{st} charge capacity.

The results ae shown as a capacity retention (%) in Table 3.

TABLE 3

| | Capacity retention (%) |
|---|---|
| Example 1 | 95 |
| Example 2 | 95 |
| Example 3 | 92 |
| Example 4 | 89 |
| Comparative Example 1 | 75 |
| Comparative Example 2 | 69 |
| Comparative Example 3 | 70 |
| Comparative Example 4 | 65 |
| Comparative Example 11 | 82 |
| Reference Example 10 | 54 |
| Reference Example 12 | 50 |

As shown in Table 3, Examples 1 to 4 exhibited an excellent capacity retention rate, compared to Comparative Examples 1 to 4 and 11 and Reference Examples 10 and 12. Referring to the results, Comparative Examples 1 to 4, in which each adhesive layer included Al₂O₃ and a binder (PVdF and PVdF-HFP), wherein boehmite and Al₂O₃ had the same average size, exhibited excellent dry and wet adhesive forces but a deteriorated capacity retention rate.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims. Therefore, the aforementioned embodiments should be understood to be exemplary but not limiting the present invention in any way.

1. A separator for a rechargeable lithium battery, the separator comprising:
a porous substrate;
a coating layer positioned on at least one surface of the porous substrate and including polyethylene particles and a first ceramic in a weight ratio of 6:4 to 8:2; and
an adhesive layer positioned on one surface of the coating layer and including a second ceramic and a binder in a weight ratio of 7:3 to 5:5,
wherein the binder comprises polyvinylidene fluoride and a polyvinylidene-hexapropylene copolymer in a weight ratio of 6:4 to 4:6, and
the first ceramic and the second ceramic have different average sizes.

2. The separator for a rechargeable lithium battery as claimed in claim 1, wherein a mixing ratio of the second ceramic and the binder is a weight ratio of 6:4 to 5:5.

3. The separator for a rechargeable lithium battery as claimed in claim 1, wherein an average size of the first ceramic is larger than an average size of the second ceramic.

4. The separator for a rechargeable lithium battery as claimed in claim 1, wherein an average size of the first ceramic is 550 nm to 750 nm.

5. The separator for a rechargeable lithium battery as claimed in claim 1, wherein a thickness of a single layer of the coating layer is 0.5 μm to 5 μm.

6. The separator for a rechargeable lithium battery as claimed in claim 1, wherein a thickness of a single layer of the adhesive layer is 0.1 μm to 4.0 μm.

7. The separator for a rechargeable lithium battery as claimed in claim 1, wherein a size ratio of the first ceramic and the second ceramic is 5:1 to 1.5:1.

8. The separator for a rechargeable lithium battery as claimed in claim 1, wherein one of the first ceramic and the second ceramic comprises one or more of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

9. The separator for a rechargeable lithium battery as claimed in claim 1, wherein the first ceramic is boehmite, and the second ceramic is Al₂O₃.

10. The separator for a rechargeable lithium battery as claimed in claim 1, wherein the coating layer further includes a vinyl group-containing binder.

11. The separator for a rechargeable lithium battery as claimed in claim 10, wherein the vinyl group-containing binder includes a (meth)acrylic copolymer including a first structural unit derived from (meth)acrylamide, and a second structural unit including at least one of a structural unit derived from one or more of (meth)acrylic acid, (meth)acrylate, and (meth)acrylonitrile, and a structural unit derived from one or more of (meth)acrylamidosulfonic acid and a (meth)acrylamidosulfonate salt.

12. The separator for a rechargeable lithium battery as claimed in claim 1, wherein an average size of the polyethylene particles is 0.1 μm to 3.0 μm.

13. The separator for a rechargeable lithium battery as claimed in claim 1, wherein a weight average molecular weight (Mw) of the polyethylene is 1000 g/mol to 5000 g/mol.

14. A rechargeable lithium battery, comprising
a negative electrode including a negative electrode active material;
a positive electrode including a positive electrode active material;
the separator as claimed in claim 1, between the negative electrode and the positive electrode; and
a non-aqueous electrolyte.
